(19) United States
(12) Patent Application Publication
(10) Pub. No.: US 2024/0263964 A1
(43) Pub. Date: Aug. 8, 2024

(54) ROUTE MANAGEMENT FOR MAPPING DATA COLLECTION

(71) Applicant: GM Cruise Holdings LLC, San Francisco, CA (US)

(72) Inventors: Swarnakshi Kapil, Sunnyvale, CA (US); Garrett Rich, Seattle, WA (US); Swinburn Miranda, Redwood City, CA (US); Irfan Lone, Milpitas, CA (US); Luke Zheng, Redwood City, CA (US); Yanni Cao, San Mateo, CA (US); Yu Chun Wei, Foster City, CA (US); Jumar Martin, Charlotte, NC (US); Azra Skeljo, San Francisco, CA (US)

(73) Assignee: GM Cruise Holdings LLC, San Francisco, CA (US)

(21) Appl. No.: 18/165,237

(22) Filed: Feb. 6, 2023

(51) Int. Cl. G01C 21/00; G01C 21/34

(52) U.S. Cl. CPC G01C 21/3841; G01C 21/3415; G01C 21/3815

(57) ABSTRACT

To improve mapping data collection, a route management system and a user application to assist drivers of a fleet of mapping vehicles are implemented. A route management system can improve route creation, assignment, monitoring, and validation. The user application can provide turn-by-turn instructions to a driver to complete a mapping route, thereby obviating the need for a navigator. The user application can also solicit user feedback from the driver if a road segment was missed. User feedback can be used to update coverage information. The coverage information may be used by the route management system to modify assigned mapping routes or assign new mapping routes to the fleet of mapping vehicles.

### BACKGROUND

### Technical field

The present disclosure generally relates to autonomous vehicles and, more specifically, to route management for mapping data collection.

### Introduction

Autonomous vehicles (AVs), also known as self-driving cars, and driverless vehicles, may be vehicles that use multiple sensors to sense the environment and move without human input. Automation technology in the AVs may enable the vehicles to drive on roadways and to accurately and quickly perceive the vehicle's environment, including obstacles, signs, and traffic lights. Autonomous technology may utilize geographical information and semantic objects (such as parking spots, lane boundaries, intersections, crosswalks, stop signs, traffic lights) for facilitating the vehicles in making driving decisions. The vehicles can be used to pick-up passengers and drive the passengers to selected destinations. The vehicles can also be used to pick-up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a map that can be provided to a navigator that accompanies a driver of a mapping vehicle, according to some aspects of the disclosed technology;

FIG. 2 illustrates a geographical map of an exemplary geographical area to be mapped, according to some aspects of the disclosed technology;

FIG. 3 illustrates the exemplary geographical area to be mapped illustrated in FIG. 2 divided into polygons, according to some aspects of the disclosed technology;

FIG. 4 illustrates an exemplary road segment graph, according to some aspects of the disclosed technology;

FIG. 5 illustrates an exemplary system having a fleet of mapping vehicles and a route management service, according to some aspects of the disclosed technology;

FIG. 6 illustrates an exemplary system having a fleet of mapping vehicles, a route management service, post-processing, and a mapping data visualizer, according to some aspects of the disclosed technology;

FIG. 7 illustrates one or more user interactions through a user device provided with a mapping vehicle, according to some aspects of the disclosed technology;

FIG. 8 illustrates one or more further user interactions through a user device provided with a mapping vehicle, according to some aspects of the disclosed technology;

FIG. 9 illustrates one or more yet further user interactions through a user device provided with a mapping vehicle, according to some aspects of the disclosed technology;

FIG. 10 is a flow diagram illustrating an exemplary computer-implemented method for method for managing mapping data collection performed by a fleet of mapping vehicles, according to some aspects of the disclosed technology;

FIG. 11 is a flow diagram illustrating another exemplary computer-implemented method for managing mapping data collection performed by a fleet of mapping vehicles, according to some aspects of the disclosed technology;

FIG. 12 is a flow diagram illustrating an exemplary computer-implemented method for method for generating turn-by-turn instructions to a driver of a mapping vehicle and soliciting user feedback regarding a missed road segment, according to some aspects of the disclosed technology, according to some aspects of the disclosed technology;

FIG. 13 illustrates an example of an AV management system, according to some aspects of the disclosed technology; and

FIG. 14 illustrates an example processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

AVs can provide many benefits. For instance, AVs may have the potential to transform urban living by offering opportunities for efficient, accessible, and affordable transportation. Services provided by AVs may include ridehailing, ridesharing, delivery, etc. For some AVs, having quality and sufficient mapping data of an area can benefit on-road operations of an AV, and training and testing of operations of an AV.

When an AV is operating on the road, the AV may be equipped with various sensors to sense an environment surrounding the AV and collect sensor data to assist the AV in making driving decisions. To that end, the collected information or sensor data may be processed and analyzed to perceive the AV's surroundings, extract information related to navigation, and predict future motions of the AV and/or other traveling agents in the AV's vicinity. The predictions may be used to plan a path for the AV. Subsequently, instructions can be sent to a controller to control the AV (e.g., for steering, accelerating, decelerating, braking, etc.) according to the planned path. As part of perception, the AV may leverage mapping data collected using a fleet of mapping vehicles, when classifying objects in the AV's surroundings (e.g., determine what objects are permanent road features, and what objects are other traveling agents in the AV's vicinity). As part of planning, the AV may access mapping data and localize itself accurately and precisely based on location information and the mapping data.

Before AV software is applied to AVs operating on the road, operations of AV software may be trained and/or tested through thousands of miles of simulated driving, referred to as simulations. In a simulation, a virtualized AV may operate in a virtualized environment, and results of the simulation can be recorded and analyzed. Many simulations can be run in parallel, to enable massive training and testing of operations of AVs. Virtual environments can be generated based on mapping data collected using a fleet of mapping vehicles. Accordingly, simulations may utilize quality mapping data for training and testing operations of AVs.

Collecting quality and sufficient mapping data for an area can be a costly, time-consuming, and manual process. The process can be very tedious because of the specific requirements to collect high quality, meaningful mapping data that is good enough for further processing. Mapping data, as used herein, is not the same as semantic map data, and is not the same as sensor data that is collected by an AV while the AV is operating normally on the road. Mapping data includes rich sensor data and location data (having position and orientation) that survey the environment and the objects within the environment. A mapping vehicle may have military-grade (e.g., high-fidelity, highly accurate, expensive) mapping and positioning sensors to determine location data of the mapping vehicle as the mapping vehicle navigates and scans the environment. The location data collected by a mapping vehicle may be far more precise than location data collected by positioning sensors on a consumer mobile device, or on a vehicle or autonomous vehicle. Based on (highly precise) location data, the rich sensor data is transformed into a multi-dimensional virtualized environment.

Once the mapping data is collected by mapping vehicles, the mapping data may be processed into map tiles. The map tiles may be later processed or labeled by map labelers. For these further processing tasks to be performed successfully, mapping vehicles may need to drive through roads multiple times to ensure there are no occlusions. Occlusions may include trucks blocking the road, objects obstructing the camera's view, etc.

Human drivers and human navigators to assist the drivers are hired to operate mapping vehicles and to drive through the roads to collect mapping data. At the beginning of a shift of a driver-navigator pair, the navigator may be provided with a (paper) map with a mapping route. The mapping route may be manually drawn or created by a human manager visually inspecting a map of the area.

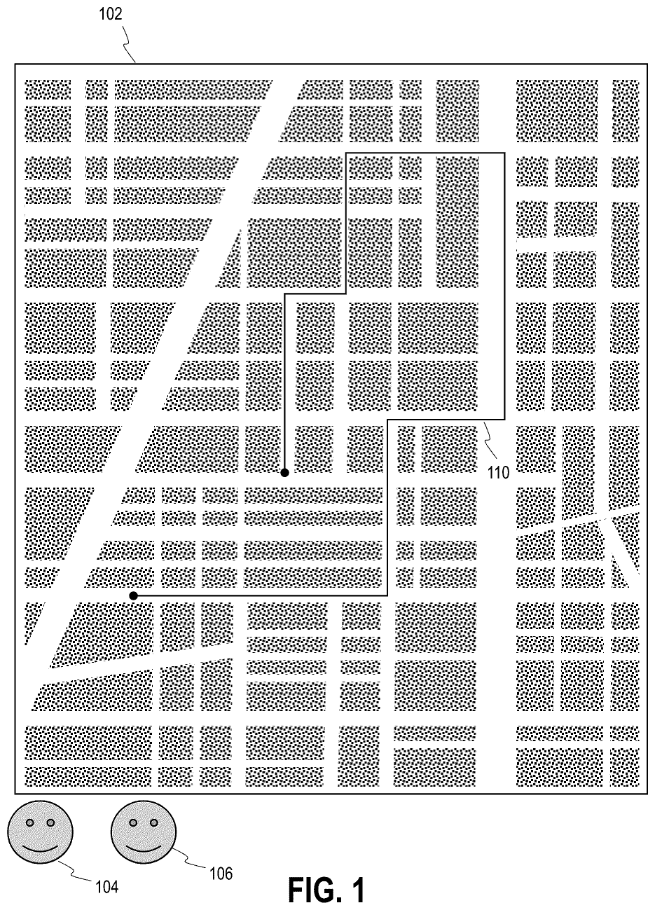

FIG. 1 illustrates a map 102 that can be provided to a navigator 106 that accompanies a driver 104 of a mapping vehicle, according to some aspects of the disclosed technology. The map 102 may include a mapping route 110. In some cases, the mapping route 110 drawn by the manager may include lane-level instructions (e.g., driver must drive in the left lane on Main Street). The map 102 may be static, and the navigator 106 is instructed to assist the driver 104 to drive the mapping vehicle through the mapping route 110 during the shift. The navigator 106 may inform the manager that the driver-navigator pair had successfully driven on mapping route 110. Mapping data collected may be uploaded to a remote system for processing. If it is determined that the quality of the mapping data collected was insufficient in a certain location, the manager may receive a re-drive request for the location. The manager may determine a new mapping route, and provide a new (printed) map with the new mapping route drawn on the map to the driver-navigator pair or another driver-navigator pair, to return to the location to collect mapping data again. Many parts of the process are manual, time-consuming, expensive, inefficient, and prone to human error.

To improve mapping data collection, a route management system and a driver application to assist drivers of a fleet of mapping vehicles are implemented. A route management system can improve route creation, assignment, monitoring, and validation. The driver application can provide turn-by-turn instructions to a driver to complete a mapping route, thereby obviating the need for a navigator. The driver application can also solicit user feedback from the driver if a road segment was missed. User feedback can be used to update coverage information. The coverage information may be used by the route management system to modify assigned mapping routes or assign new mapping routes to the fleet of mapping vehicles.

### Generating a Road Segment Graph for an Area to be Mapped

AVs may operate in an operational design domain (ODD), which encompasses conditions, use cases, restrictions, and scenarios that AVs may encounter. In some cases, one of the components or factors of ODD may be a geographical area. Mapping data may be collected for the geographical area of an ODD. To collect mapping data for the geographical area, mapping routes can be generated using a computer-implemented method.

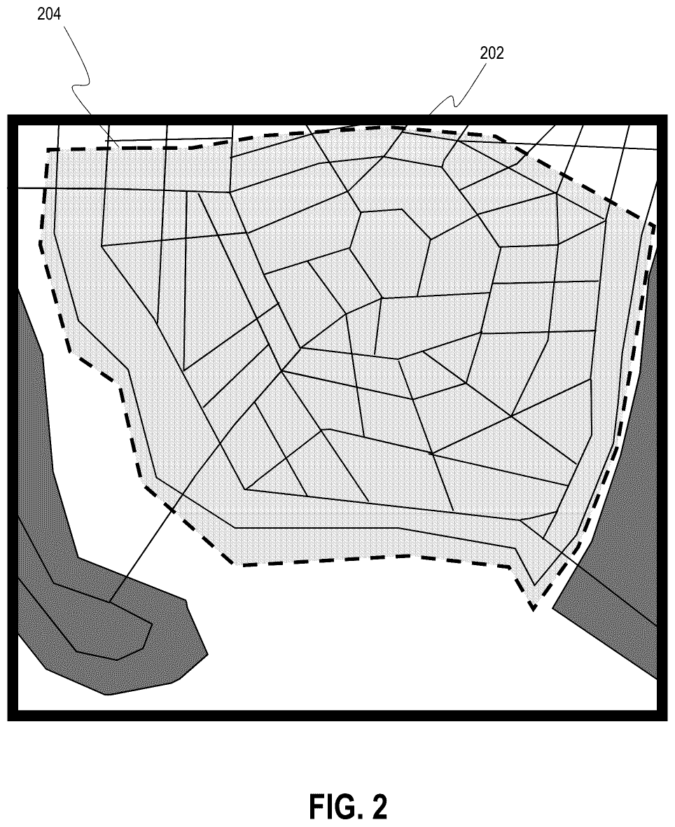

FIG. 2 illustrates a geographical map 202 of an exemplary geographical area to be mapped, according to some aspects of the disclosed technology. The geographical map 202 may be generated using a semantic map data source. The geographical map 202 may be a visualization of semantic map data. Semantic map data may include data of environmental features such as points of interests, civil area boundaries, rivers, intersections, and roads. Data may include names, geographical location information, geometric measurements (e.g., width and length), elevation, speed limits, number of lanes, traffic volume, zoning information, etc. An exemplary ODD may have an associated area, such as a city, a town, or a neighborhood. Mapping data may be collected for the area of the ODD using a fleet of mapping vehicles. The area of the ODD may be specified by a polygon 204. The area may have various (connected) road segments for the fleet of mapping vehicles to drive on. As used herein, road segments may include portions of a roadway (e.g., portions of roadway having a certain length, a portion of a roadway having a certain width), and intersections.

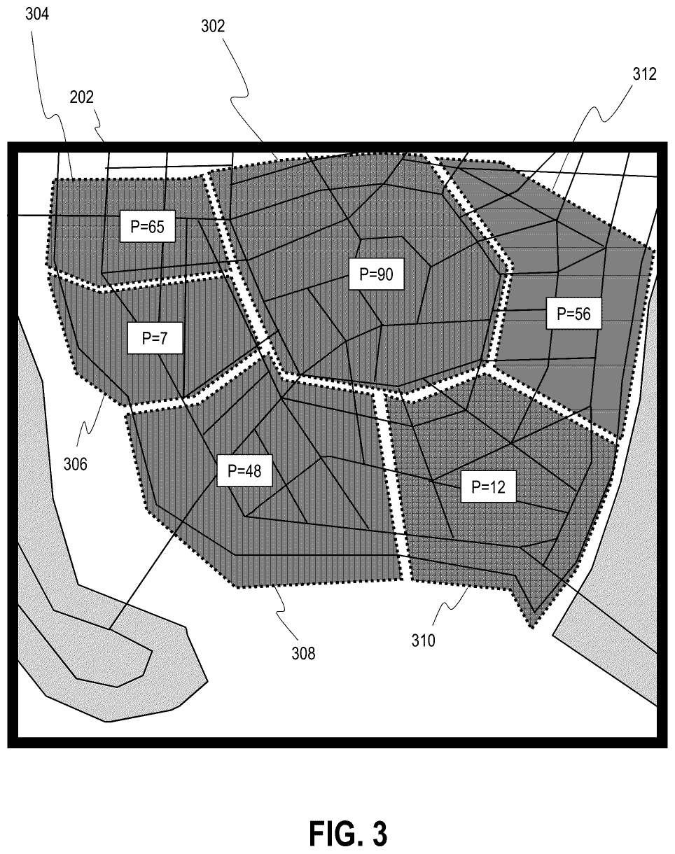

FIG. 3 illustrates the exemplary geographical area to be mapped illustrated in FIG. 2 divided into polygons, according to some aspects of the disclosed technology. In some cases, the area defined by an ODD may encompass a relatively large area. The geographical area bounded by polygon 204 in FIG. 2 maybe divided into smaller areas, or polygons 302, 304, 306, 308, 310, and 312. The smaller areas may be neighborhoods. The polygons 302, 304, 306, 308, 310, and 312 may or may not overlap with each other. The polygons 302, 304, 306, 308, 310, and 312 may have different shapes or sizes.

A geographical area of an ODD may be manually divided into smaller areas. A geographical area of an ODD may be divided into smaller areas using various computer-implemented algorithms. One exemplary algorithm may divide the geographical area into a grid of rectangles as polygons. Another algorithm may divide the geographical area into polygons based on civil area boundaries from semantic map data. Another algorithm may (evenly) divide the geographical area into polygons of substantially the same size. Another algorithm may (evenly) divide the geographical area into polygons having substantially the same number of road segments.

The polygons 302, 304, 306, 308, 310, and 312 may have different assigned priorities. Accordingly, road segments within a polygon may inherit the priority of the polygon. The priorities are illustrated as P values in the figure. Polygon 302 may have a P value of 90, polygon 304 may have a P value of 65, and so forth. P values may indicate a level of priority (or urgency) for collecting mapping data for the road segments in the polygon. P values may enable quantitative ranking of the polygons (and the road segments within the polygons). Priority values may be numerical (e.g., numbers on a scale). Priority values may include a set of different levels of priorities (e.g., high, medium, low). Priority values may change over time, depending on the underlying factors that may impact the priority values.

Priority values may be manually assigned to polygons. Priority values may be determined or assigned using various computer-implemented algorithms. One exemplary algorithm may assign priority values to polygons based on coverage information associated with the road segments in the polygons. If coverage information of a polygon indicates low mapping coverage, the priority value for the polygon may indicate a high level of priority or urgency. Another exemplary algorithm may assign priority values to polygons based on semantic map information. If semantic map information indicates that traffic patterns within a polygon are ideal for mapping (e.g., certain time of the day or day of the week), the priority value for the polygon may indicate a high level of priority or urgency to map the road segments in the polygon.

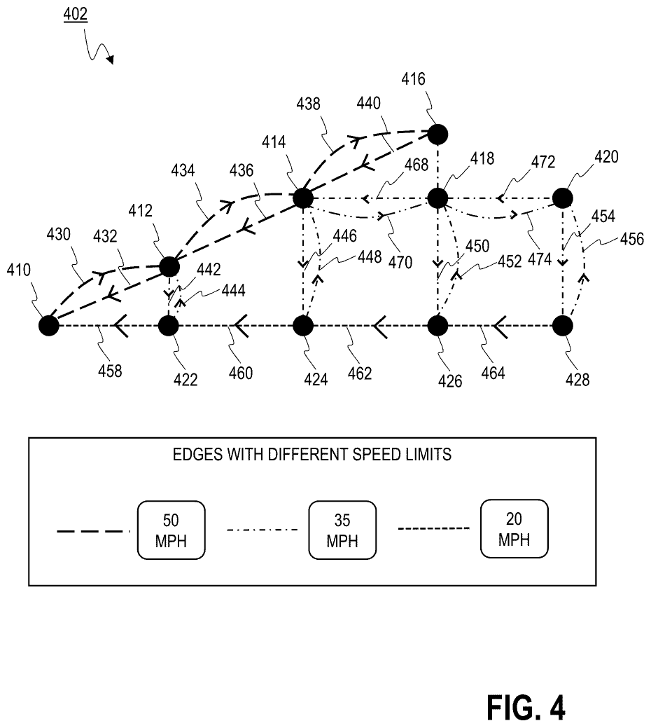

For a given polygon (or area), using a semantic map data source, a road segment graph can be generated for the road segments in the polygon using a computer-implemented method. FIG. 4 illustrates an exemplary road segment graph 402, according to some aspects of the disclosed technology. The road segment graph 402 may be a directed graph having nodes and edges. Nodes of road segment graph 402 may include exemplary nodes 410, 412, 414, 416, 418, 420, 422, 424, 426, and 428. Edges are illustrated as various broken lines connecting nodes in the figure. Edges of road segment graph 402 may include exemplary edges 430, 432, 434, 436, 438, 440, 442, 444, 446, 448, 450, 452, 454, 456, 458, 460, 462, 464, 468, 470, 472, and 474. For example, edge 430 may connect node 410 and node 412, in the direction from node 410 to node 412. Edge 432 may connect node 412 and node 410, in the direction from node 412 to node 410. Edge 442 may connect node 412 and node 422, in the direction from node 412 to node 422. Edge 444 may connect node 422 and node 412, in the direction from node 422 to node 412. Edge 458 may connect node 422 and node 410, in the direction from node 422 to node 410.

In some cases, nodes may represent road segments (e.g., intersections or connecting areas) that connect other road segments. Edges may represent road segments (e.g., a length of a roadway). Directionality of edges may represent a driving direction of a particular road segment. For simplicity, the road segment graph 402 represents a relatively small set of (connected) road segments. A road segment graph 402 for a polygon, in practice, may include, e.g., hundreds to thousands of nodes and edges. The nodes and edges may have corresponding priority values. The priority values may be inherited from the priority value of the area/polygon in which a given node or edge is located. The nodes and/or edges may have corresponding speed limits, as illustrated in FIG. 4. For example, edge 430 may have a 50 miles per hour (MPH) speed limit. Edge 458 may have a 20 MPH speed limit. Edge 442 may have a 35 MPH speed limit.

### Using a Road Segment Graph to Create and Assign Mapping Routes

Once a road segment graph is created for a polygon or polygons of an ODD, a structured and strategic approach can be applied to create, schedule, optimize, and assign mapping routes to mapping vehicles in a fleet. Nodes and/or edges of the road segment graph may have corresponding data or information about the node or edge (i.e., a road segment). The data or information may include information that may assist or guide creation and generation of mapping routes for the fleet of mapping vehicles, where the mapping routes may be optimized to effectively and efficiently achieve sufficient mapping data coverage of one or more areas (or polygons).

The data or information may indicate priority/urgency of a road segment to be mapped (e.g., a priority value). The data or information may include prioritization information of the road segment (e.g., priority of the polygon that contains the road segment as illustrated in FIG. 3). When generating mapping routes, prioritization information may be used to generate and schedule mapping routes that cover higher priority road segment graphs first.

Various kinds of information associated with nodes and/or edges of a road segment graph may define or inform priorities of the nodes and/or edges.

### Using a Road Segment Graph to Maintain and Track Mapping Data Coverage Information

A road segment graph enables structured and quantitative tracking and maintenance of mapping data coverage information for nodes and edges of the road segment graph. The road segment graph provides a structure for organizing data or information associated with nodes or edges (e.g., priority information, speed limit, and mapping data coverage information). Various algorithms can process the data or information associated with nodes and edges of the road segment graph to generate and schedule mapping routes.

The data or information associated with nodes or edges (e.g., road segments) may include mapping data coverage information indicating how well the (already) collected mapping data covers the road segment, which can be determined based on one or more mapping data coverage metrics for a given node or edge. For example, nodes and edges of road segment graph 402 in FIG. 4 may have corresponding mapping data coverage information. In some cases, the mapping data coverage information is separate from the prioritization information. In some cases, the mapping data coverage information is a factor in determining the prioritization information.

The mapping data coverage information for a node or an edge may indicate whether the node or the edge has been driven by a mapping vehicle in the fleet or has not been driven by a mapping vehicle in the fleet. For example, node 412 of road segment graph 402 in FIG. 4 may have a corresponding value of “1” to indicate that the node has been driven by one or more mapping vehicles. Edge 464 of road segment graph 402 in FIG. 4 may have a corresponding value of “0” to indicate that the edge has not been driven by a mapping vehicle.

In some embodiments, the mapping data coverage information for a node or an edge may indicate a number of times one or more mapping vehicles in the fleet has driven past the node or through the edge of the road segment graph. For example, node 412 of road segment graph 402 in FIG. 4 may have a corresponding value of “3” to indicate that the node has been driven by one or more mapping vehicles three times. Edge 464 of road segment graph 402 in FIG. 4 may have a corresponding value of “0” to indicate that the edge has been driven by a mapping vehicle zero times (has not been driven by a mapping vehicle).

In some embodiments, the mapping data coverage information for a node or an edge may be expressed as a selection from a set of coverage levels (e.g., good coverage, OK coverage, and poor coverage by mapping vehicles) For example, node 412 of road segment graph 402 in FIG. 4 may have a corresponding value of “good-coverage” to indicate that the node has good coverage. Node 424 of road segment graph 402 in FIG. 4 may have a corresponding value of “OK-coverage” to indicate that the node has OK coverage. Edge 464 of road segment graph 402 in FIG. 4 may have a corresponding value of “poor-coverage” to indicate that the edge has poor coverage.

In some embodiments, the mapping data coverage information for a node or an edge may be expressed as a numerical value (e.g., a value selected from a scale or range of values). For example, node 412 of road segment graph 402 in FIG. 4 may have a corresponding value of “10” to indicate that the node has good/full coverage. Node 424 of road segment graph 402 in FIG. 4 may have a corresponding value of “5” to indicate that the node has OK/half coverage. Edge 464 of road segment graph 402 in FIG. 4 may have a corresponding value of “0” to indicate that the edge has poor/zero coverage. The possible values may be in a range from 0 to 10.

In some embodiments, the mapping data coverage information for a node or an edge may be expressed as a percentage or fraction. For example, node 412 of road segment graph 402 in FIG. 4 may have a corresponding value of “100%” to indicate that the node has good/full coverage. Node 424 of road segment graph 402 in FIG. 4 may have a corresponding value of “50%” to indicate that the node has OK/half coverage. Edge 464 of road segment graph 402 in FIG. 4 may have a corresponding value of “0%” to indicate that the edge has poor/zero coverage.

Mapping data coverage information associated with nodes and edges of the road segment graph (e.g., whether the road segment has or is likely to have sufficiently good mapping data) can be determined based on coverage metrics. Accordingly, mapping data coverage information of the ODD can be quantitatively measured based on aggregated mapping data coverage information of the nodes/edges of the road segment graph of the ODD. The mapping data coverage information of the nodes/edges of the road segment graph, and/or mapping data coverage information of the ODD, can in turn aid creating, scheduling, optimizing, and assigning mapping routes. In some embodiments, mapping data coverage information is an input used for optimizing mapping routes. In some embodiments, prioritization information and mapping data coverage information are two inputs used for optimizing mapping routes.

Mapping data coverage metric, as used herein, are quantitative measurements of mapping data coverage of a road segment that would indicate that the collected mapping data from mapping vehicles driving on a given road segment is of sufficiently good quality (e.g., covering a whole width of a road segment, cover all lanes of a road segment, free of occlusions, free of ghosting or other artifacts). Mapping data coverage metric can be used to determine mapping data coverage information of nodes/edges of a road segment graph.

Various kinds of information associated with nodes and/or edges of a road segment graph may define mapping data coverage metrics of the nodes and/or edges. More specifically, some data or information about the road segment may be used as heuristics to define one or more mapping data coverage metrics. For example, some data or information about a road segment may be used as a heuristic to determine how many times a mapping vehicle needs to drive past a node or through an edge of the road segment graph to collect sufficiently good quality mapping data, and to count the road segment as properly or sufficient driven or covered by the mapping vehicles. In some cases, the data or information about a road segment may be used as heuristics to define how well a given node or edge (i.e., a road segment) needs to be covered in terms of width or area of the road segment.

Data or information associated with nodes and/or edges of a road segment graph may include speed limits of the road segment (e.g., edges in road segment graph 402 may have different speed limits as shown in FIG. 4), number of lanes in one or either direction, width of the road segment, presence of road features in the road segment (e.g., curb, shoulder, median), curvature of road segment, whether the road segment is an intersection or not an intersection, distance of the road segment to an intersection, zoning information of the road segment, classification of the road segment (e.g., freeway, highway, industrial road, private road, residential road, unpaved road, rural road, one-way or two-way, etc.), number of road segments meeting at an intersection (e.g., number of edges connected to a node), traffic pattern information, presence of a recent map change, presence of road construction, etc.

In some embodiments, mapping data coverage information may include a number of times one or more mapping vehicles in the fleet has driven past the node or through the edge of the road segment graph. To determine if the node or edge is covered or not, a mapping data coverage metric can be defined based on a minimum number. The mapping data coverage information for a node or an edge may indicate the node or the edge is covered by the fleet of mapping vehicles if the number of times one or more mapping vehicles in the fleet has driven past the node or through the edge of the road segment graph meets a minimum number, and may indicate the node or the edge is not-covered by the fleet of mapping vehicles if the number of times one or more mapping vehicles in the fleet has driven past the node or through the edge of the road segment graph does not meet the minimum number. This minimum number in the mapping data coverage metric can be informed by one or more heuristics, such as a speed limit of the road segment, whether the road segment is at or near an intersection, a number of lanes in the road segment, number of edges connected to a node, etc.

For example, edge 434 of FIG. 4 has a 50 MPH speed limit, edge 448 has a corresponding 35 MPH speed limit, and edge 462 has a corresponding 20 MPH speed limit. The mapping data coverage metric (e.g., a minimum number of times that one or more mapping vehicles has driven past the road segment) that can be used to determine if the edge is covered or not may be determined based on the speed limit. Edge 434 may have a metric with a minimum number of 8. If one or more mapping vehicles have driven past the road segment corresponding to edge 434 at least 8 times, edge 434 may be considered covered. Edge 448 may have a metric with a minimum number of 5. If one or more mapping vehicles have driven past the road segment corresponding to edge 448 at least 5 times, edge 448 may be considered covered. Edge 462 may have a metric with a minimum number of 2. If one or more mapping vehicles have driven past the road segment corresponding to edge 462 at least 2 times, edge 462 may be considered covered. The higher the speed limit, the higher may be the minimum number.

For example, node 412 may have 6 edges connected to node 412, and node 428 may have 3 edges connected to node 428. The number of edges may be an indicator for a number of possible paths through an intersection. The mapping data coverage metric (e.g., a minimum number of times that one or more mapping vehicles has driven past the road segment) that can be used to determine if the node is covered or not may be determined based on a number of edges connected to a node. Node 412 may have a metric with a minimum number of 10. If one or more mapping vehicles have driven past the road segment corresponding to node 412 at least 10 times, node 412 may be considered covered. Node 428 may have a metric with a minimum number of 6. If one or more mapping vehicles have driven past the road segment corresponding to node 428 at least 6 times, node 428 may be considered covered. The higher the number of edges connected to a node, the higher may be the minimum number.

In some embodiments, mapping data coverage information may include a binary value indicating whether a node or edge is covered/driven or not-covered/not-driven.

In some embodiments, the mapping data coverage information may include finer-grained information indicating whether an individual portion of a node or edge is covered/driven or not-covered/not-driven. A node or edge may have individual portions corresponding to certain sides of a road segment (e.g., left, right, middle, etc.), or certain lanes of a road segment (e.g., lane 1, lane 2, lane 3, etc.). For example, the information may indicate that a left-side of the node or edge is covered and a right-side of the node or edge is not-covered. In another example, the information may indicate that a left lane of the node or edge is covered, and a right lane of the node or edge is not-covered.

### Route Management for a Fleet of Mapping Vehicles

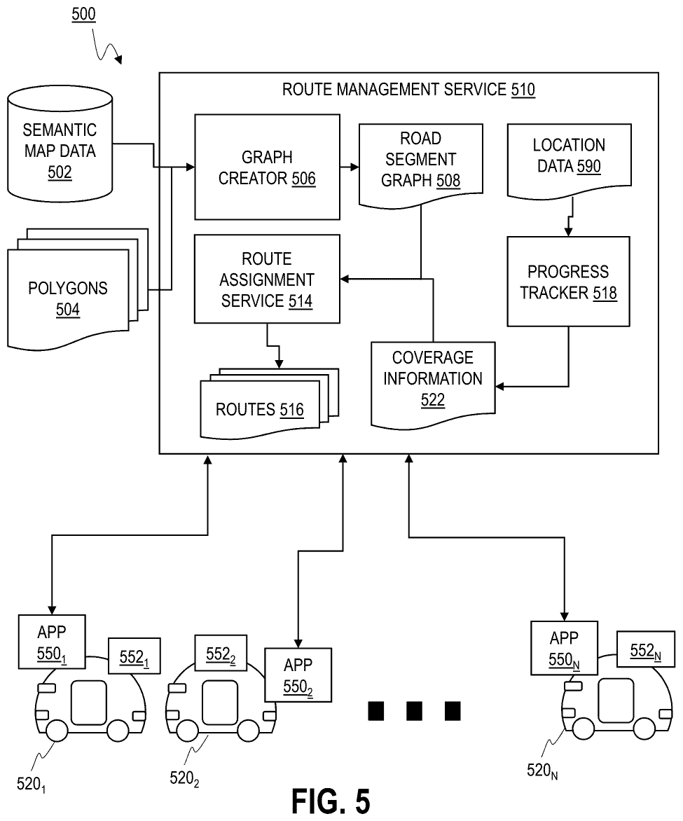

FIG. 5 illustrates an exemplary system 500 having a fleet of mapping vehicles 520 and a route management service 510, according to some aspects of the disclosed technology.

System 500 includes a fleet of mapping vehicles, which are illustrated as N number of mapping vehicles 520₁-520_{N}. Any suitable number of mapping vehicles 520 may be used. Mapping vehicles 520 may include road vehicles. Mapping vehicles may include aerial vehicles such as drones. Drivers of the mapping vehicles 520 may operate different shifts. Preferably, a navigator is no longer needed since a (paper) map is no longer used. Instead, drivers are provided with turn-by-turn instructions through an application running on a user device to complete an assigned mapping route.

One or more mapping vehicles 520 can be used to gather mapping data, using sensors 552₁-552_{N}. The sensors 552 may include a highly accurate (e.g., military-grade) location sensor that can record accurate position and orientation data of the mapping vehicle. The sensors 552 may include a location sensor that can record highly accurate position (and orientation) data of the mapping vehicle. The sensors 552 may include one or more of: vibrational sensors, electromagnetic frequency sensors, gyroscopes, microphones, capacitive sensors, cameras, light detection and ranging (LIDAR) sensors, and radio detection and ranging (RADAR) sensors. AVs that leverage the mapping data collected (e.g., for mapping and localization, for testing and training, etc.) may have a similar set of sensors. As a mapping vehicle navigates around an environment, data streams from sensors 552 can be recorded onto one or more storage devices on the mapping vehicle.

One or more mapping vehicles 520 may each include a user device (e.g., a mobile computing device, such as mobile phone, a touch-sensitive display, or a tablet) that implements a driver application shown as 550₁-550_{N}. The user device having the driver application 550 running thereon is co-located with the mapping vehicle 520, and can track location of the user device and the mapping vehicle 520. The driver application can receive assigned mapping route(s) and implement a user interface for interacting with the driver of a mapping vehicle. The driver application 550 can implement a user interface to assist the driver (e.g., in a hands-free manner) to complete an assigned mapping route, even without a navigator. For example, the driver application 550 may generate turn-by-turn instructions for the driver to complete an assigned mapping route, and the turn-by-turn instructions may be output to the driver through the user interface provided by driver application 550.

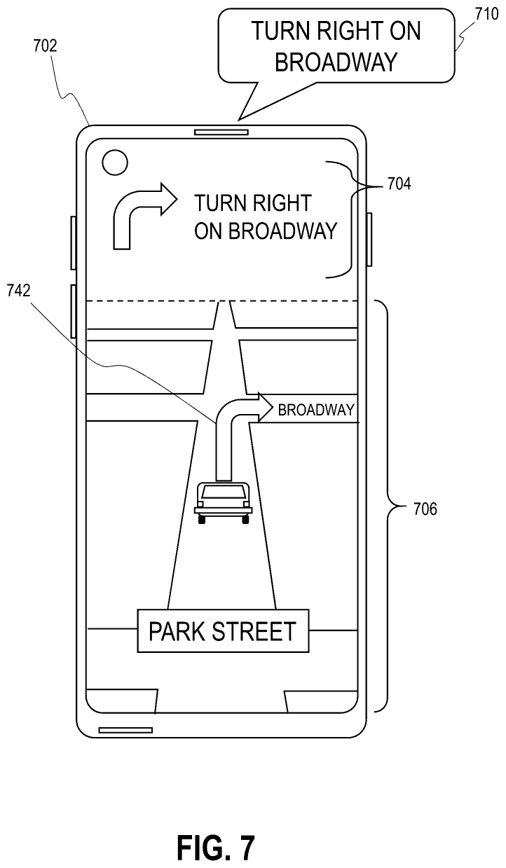

In some embodiments, the driver application 550 (or a separate remote service) can use location information collected by the user device and/or the mapping vehicle to determine whether a road segment in an assigned mapping route has been missed. If a road segment has been missed, the user interface of the driver application 550 may prompt the driver for user feedback information on the missed road segment. In some embodiments, the route management service 510 may receive user feedback information from drivers of the fleet of mapping vehicles 520 regarding one or more missed road segments of assigned mapping routes 516. The user feedback information can be received via and from the driver application 550. For example, the driver application may receive user feedback from a user interface of driver application 550 that indicates whether the road segment was missed due to one of the following reasons: (1) permanent inaccessibility; (2) temporary inaccessibility; (3) driver mistake; and (4) other. The road segment graph 508 may be updated based on or in accordance with the user feedback information. Illustrations for the user interface implemented by the driver application are described in greater detail with FIGS. 7-9.

System 500 further includes a route management service 510. Route management service 510 includes a graph creator 506, route assignment service 514, and progress tracker 518.

Graph creator 506 can create a road segment graph 508 (e.g., road segment graph 402 of FIG. 4), based on semantic map data 502 and polygons 504. A polygon in polygons 504 may represent an ODD or a portion of an ODD (e.g., as illustrated by FIGS. 2-3). Graph creator 506 can implement a process as described herein to generate a road segment graph 508 for a given polygon or ODD.

Route assignment service 514 may be an optimizer and/or scheduler that can assign mapping routes to the fleet of mapping vehicles 520. Route assignment service 514 can generate mapping routes 516 to cover not-driven or not-covered road segments, using, e.g., road segment graph 508, and/or (mapping data) coverage information 522. The list of mapping routes 516 may have associated (unique) identifiers for tracking purposes. A mapping route in mapping routes 516 may include (connected) road segments of the road segment graph. In some embodiments, route assignment service 514 can generate a list of mapping routes 516 based on a road segment graph 508 of an operational design domain. In some embodiments, route assignment service 514 can generate a list of mapping routes 516 based on prioritization information corresponding to nodes and edges of the road segment graph. In some embodiments, route assignment service 514 may generate the list of mapping routes 516 based on mapping data coverage information 522 corresponding to nodes and edges of the road segment graph. Using mapping data coverage information 522, route assignment service 514 can generate mapping routes 516 to cover road segments that lack sufficiently good mapping data based on quantitative coverage metrics. Using coverage information can be more efficient and effective than a human manager physically drawing a mapping route.

In some embodiments, the list of mapping routes 516 may be a prioritized list of mapping routes. The mapping routes 516 may be prioritized or ranked based on one or more factors. One exemplary factor may include priorities assigned to areas of the operational design domain (e.g., using priority values as illustrated in FIG. 3). Another exemplary factor may include coverage information corresponding to the nodes/edges of a given mapping route.

The route assignment service 514 may assign or schedule mapping routes 516 to the fleet of mapping vehicles 520. Mapping routes 516 may be scheduled to the fleet of mapping vehicles 520 based on availability of the mapping vehicles 520. Mapping routes 516 may be scheduled to the fleet of mapping vehicles 520 based on priorities/rankings corresponding to the mapping routes 516. For example, the route assignment service 514 may assign a first mapping route to a first mapping vehicle in the fleet of mapping vehicles 520. The first mapping route may include the first road segments of the road segment graph. Assigning mapping routes to various mapping vehicles 520 can take one or more factors into account, e.g., to ensure successful completion of mapping routes, for efficiency, and so forth. One or more routes assigned to a mapping vehicle may be transmitted to a queue in the driver application 550 running on a user device co-located with the mapping vehicle.

Mapping routes 516 can be assigned by route assignment service 514 to one or more mapping vehicles based on priorities of the mapping routes. For example, a mapping route can be scheduled earlier to be completed by a mapping vehicle if the mapping route has a higher priority. For example, a mapping route can be scheduled to be completed by a mapping vehicle earlier if the mapping route has higher priority road segments.

Mapping routes 516 can be assigned by route assignment service 514 to one or more mapping vehicles based on shift durations of drivers operating the fleet of mapping vehicles. For example, expected time of completion of a candidate mapping route can be determined, and checked against shift durations to ensure that the candidate mapping route respects shift durations of the driver of a mapping vehicle. In some cases, route assignment service 514 creates mapping routes 516 that do not exceed the shift durations of the drivers.

Mapping routes 516 can be assigned by route assignment service 514 to one or more mapping vehicles based on shift starting times and shift ending times of drivers operating the fleet of mapping vehicles. For example, expected time of completion of a candidate mapping route can be determined (e.g., shift starting times and shift ending times), and checked against shift starting times and shift ending times to ensure that the candidate mapping route can be successfully completed in time by a driver.

Mapping routes 516 can be assigned by route assignment service 514 to one or more mapping vehicles based on (current or starting) locations of drivers operating the fleet of mapping vehicles. Mapping routes 516 may be created by route assignment service 514 to start near the locations of drivers (or a specific mapping route may be created to start near a specific driver). A specific mapping route may be assigned to a specific driver that is near (or nearest to) a starting location of the specific mapping route.

### Data Validation of Mapping Data Collected on Mapping Routes and Updating of Coverage Information

Continuing to refer to FIG. 5, progress tracker 518 of route management service 510 can perform data validation, and track and maintain mapping data coverage information 522. Accordingly, progress tracker 518 may maintain the mapping data coverage information 522 of nodes and edges of the road segment graph 508 based on the location data 590 received from the fleet of mapping vehicles. Mapping data coverage information 522 may include, e.g., status of road segment (such as driven or not-driven), number of passes completed, and data validation result, etc. Data validation enables accurate tracking and confirmation that the mapping vehicle has driven through road segments in a mapping route as expected. Upon validating that mapping data has been collected for a given mapping route, mapping data coverage information 522 can be updated accordingly.

Progress tracker 518 may receive location data 590 of the fleet of mapping vehicles 520. The location data 590 may be provided by the driver application 550 running on a user device co-located with a mapping vehicle. The location data 590 may be measured or sensed by a location sensor of the user device. In some cases, the location data 590 may be measured by a location sensor of the mapping vehicle. The location data 590 may be included in the mapping data collected by the mapping vehicles 520.

Progress tracker 518 may validate mapping of the first mapping route based on location data 590 from the first mapping vehicle, and the first road segments of the first mapping route. More specifically, progress tracker 518 may validate the location data 590 from the first mapping vehicle against location information of the road segments in the first mapping route. In some embodiments, progress tracker 518 may validate whether individual portions of a road segment have been driven or not-driven using the location data 590 from the first mapping vehicle. Progress tracker 518 may perform a (basic) verification or check that indeed the mapping vehicle has collected mapping data that corresponds to a road segment.

Progress tracker 518 may update the mapping data coverage information 522 of nodes and edges of the road segment graph 508 based on results of the data validation. For example, the mapping data coverage information 522 (e.g., organized based on road segment graph 508) can be updated based on data validation results obtained using the location data 590 received from the fleet of mapping vehicles and location information of road segments in mapping routes completed by the fleet of mapping vehicles 520. In some cases, the mapping data coverage information 522 may include a number (e.g., count) of times a mapping vehicle has driven through a particular road segment, and updating the mapping data coverage information 522 includes incrementing the number in response to the progress tracker 518 validating that the mapping vehicle has collected mapping data for the particular road segment. In some cases, updating the mapping data coverage information 522 may include increasing a value in response to the progress tracker 518 validating that the collected mapping data corresponds to a particular road segment.

Data validation performed by progress tracker 518 can be accurate and efficient. The data validation results can also enable accurate and systematic tracking and maintenance of mapping data coverage information 522, which in turn can enable more efficient mapping routes generation being performed by route assignment service 514.

### Post-Processing of Mapping Data and Mapping Data Visualizer

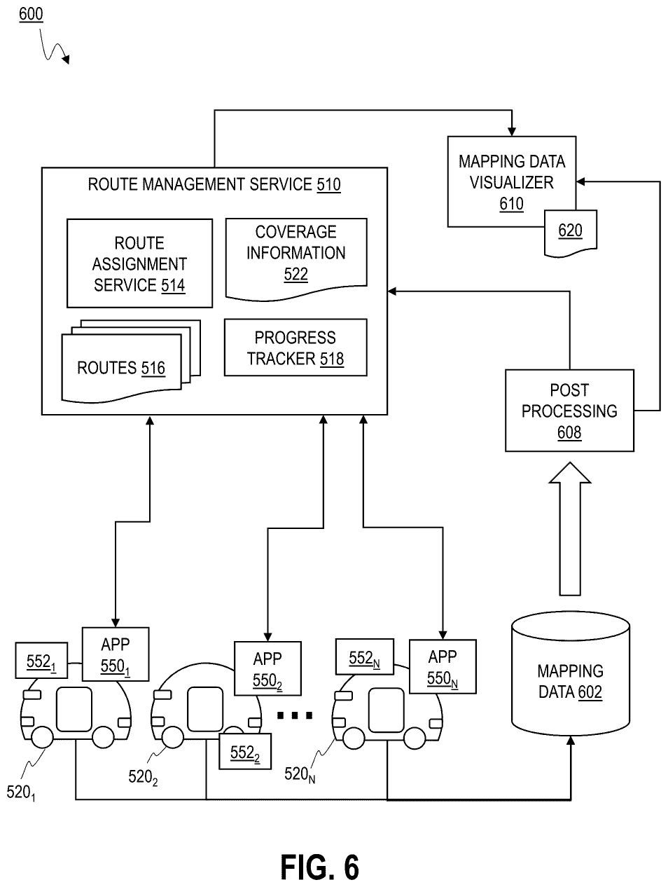

FIG. 6 illustrates an exemplary system 600 having a fleet of mapping vehicles 520, a route management service 510, post-processing 608, and a mapping data visualizer 610, according to some aspects of the disclosed technology. Mapping data collected by the fleet of mapping vehicles 520 may be stored in a mapping data storage 602. The mapping data collected on a specific mapping route may be identified by a (unique) identifier of the specific mapping route. Notifications can be triggered for post-processing of the mapping data upon receiving the mapping data from the mapping vehicles 520. Post-processing 608 may process mapping data collected on a specific mapping route to verify or confirm the quality of the mapping data.

Post-processing 608 may receive sensor data (e.g., from mapping data storage 602) from the fleet of mapping vehicles 520. Post-processing 608 may process the sensor data to validate quality of the sensor data. For example, post-processing 608 may include determining if there are occlusions, ghosting, or other artifacts in the mapping data that impact the quality of the sensor data). In response to sensor data corresponding a node or an edge (e.g., a road segment of a mapping route) not meeting a quality metric, post-processing 608 may updating the mapping data coverage information 522 corresponding to the node or the edge or cause the mapping data coverage information 522 to be updated. For example, mapping data coverage information 522 corresponding to the node or the edge may be marked as not-covered, or the mapping data coverage information 522 corresponding to the node or the edge may be downgraded, decremented, or decreased to indicate a reduction in coverage of the particular road segment, if the sensor data of the road segment fails the quality metric in post-processing 608. The modified mapping data coverage information 522 may cause assigned routes to be modified or new mapping routes to be generated or assigned to address the reduced mapping data coverage of a particular road segment.

In some cases, post-processing 608 may directly update the mapping data coverage information 522. In some cases, post-processing 608 may inform progress tracker 518 that mapping data coverage information 522 is to be updated (e.g., identifying the mapping route by the route's unique identifier), and progress tracker 518 performs the update of the mapping data coverage information 522 accordingly.

To further assist mapping operations, mapping data visualizer 610 can be implemented to provide a user interface that visualizes coverage information and/or stages of the mapping data processing pipeline. The user interface of the mapping data visualizer 610 may highlight route failures, if any. The user interface of mapping data visualizer 610 may use mapping data coverage information 522 and status information from post-processing 608 to generate visual indicators 620 for the user interface. The user interface may display a geographical map of the operational design domain. Additionally, the user interface may display an overlay of visual indicators 620 corresponding to coverage information of nodes and edges of the road segment graph. In some examples, the visual indicators 620 include a first visual indicator encoding state information indicating whether the node or the edge of the road segment graph has been driven or not-driven by the fleet of mapping vehicles. In some examples, the visual indicators 620 include a second visual indicator encoding count information indicating a number of times one or more of the mapping vehicles has driven past the node or through the edge. In some examples, the visual indicators 620 include a third visual indicator encoding state information indicating whether the count information meets a minimum number for the node or the edge. In some examples, the visual indicators 620 include a fourth visual indicator encoding progress information indicating progress of post-processing of the mapping data collected for the node or the edge. In some examples, the visual indicators 620 include a fifth visual indicator encoding mapping failure information.

In some embodiments, the visual indicators 620 may inform a manager to change the priority information of road segments of an ODD or polygons of an ODD. The manager may provide the change to the priority information through a user interface provided by mapping data visualizer 610. In turn, different mapping routes 516 may be generated by route assignment service 514 based on the modified priority information.

### Detecting Deviations From Mapping Route and Rerouting Based on User Feedback

Referring back to FIG. 5, a driver application 550 implemented on a user device co-located with a mapping vehicle 520 having a user interface that can interact with a driver of a mapping vehicle offer significant technical advantages over offering a (paper) map to a navigator with a mapping route drawn on the map. The driver application 550 can track whether a driver deviates from an assigned mapping route as the driver is driving a mapping vehicle (e.g., in real-time). For example, the driver application 550 can determine if a road segment in a mapping route has been missed. To determine whether a deviation from a mapping route has occurred, the driver application 550 can compare between (1) location information of road segments in the mapping route, and (2) the location data of the mapping vehicle or the user device and/or the location information of the mapping route.

If a deviation from the assigned mapping route is detected (e.g., based on the comparison), remediation actions can be performed to address the deviation (e.g., rerouting the driver, or routing other drivers). In addition, the driver application 550 can collect user feedback information on reasons for missing a road segment. If the road segment was missed due to permanent inaccessibility, the road segment graph 508 can be updated accordingly, so that mapping routes are not created to cover that missed road segment in the future. In some cases, the user feedback information can be used by route assignment service 514 to update the road segment graph 508, which can affect mapping routes 516 to be generated by the route assignment service 514. The change to the road segment graph 508 may be permanent or temporary (e.g., limited in time). In some cases, the user feedback information can be used by route assignment service 514 to reroute mapping vehicles 520 (e.g., generate mapping routes 516) to return to the missed road segment. Route assignment service 514 may reroute mapping vehicles 520 to return to the missed road segment while optimizing for efficiency (e.g., if it is more efficient for a different mapping vehicle to return to the missed road segment, then reroute that mapping vehicle to return to the missed road segment).

Once a first mapping vehicle is assigned and sent to complete a first mapping route, the driver application 550 may track the location of the user device and/or the mapping vehicle to determine whether the first mapping vehicle deviates from the first mapping route. User feedback information can be requested by the driver application 550 from the driver. Route assignment service 514 may update the road segment graph 508 accordingly and/or reroute mapping vehicles 520 accordingly.

In some embodiments, in response to the first mapping vehicle deviating from the first mapping route and an indication that a road segment was missed due to permanent inaccessibility (e.g., road does not exist, road is a private road, road is a gated road, road is a one-way street in the wrong direction, road has a concrete barrier, etc.), route assignment service 514 may remove the missed road segment from the road segment graph 508, e.g., permanently.

In some embodiments, in response to the first mapping vehicle deviating from the first mapping route and an indication that the road segment was missed due to temporary inaccessibility (e.g., road is temporarily blocked by traffic, road is blocked due to a special event, road is blocked due to a road emergency or public emergency), route assignment service 514 may disable or remove the missed road segment from the road segment graph 508, e.g., temporarily, or for a fixed period of time.

In some embodiments, in response to the first mapping vehicle deviating from the first mapping route and an indication that the road segment was missed due to temporary inaccessibility (e.g., road is temporarily blocked by traffic, road is blocked due to a special event, road is blocked due to a road emergency or public emergency), route assignment service 514 may generate a second mapping route having the missed road segment, and assign (or schedule) the second mapping route to one of the mapping vehicles in the fleet of mapping vehicles at a later time.

In some embodiments, in response to the first mapping vehicle deviating from the first mapping route and an indication that a road segment was missed due to driver mistake (e.g., driver missed the turn, driver was confused about the turn-by-turn instructions, etc.), route assignment service 514 may modify the first mapping route to reroute the first mapping vehicle to the missed road segment.

In some embodiments, in response to the first mapping vehicle deviating from the first mapping route and an indication that missed a road segment was missed due to driver mistake (e.g., driver missed the turn, driver was confused about the turn-by-turn instructions, etc.), route assignment service 514 may generate a second mapping route having the missed road segment, and assign the second mapping route to the first mapping vehicle.

In some embodiments, in response to the first mapping vehicle deviating from the first mapping route and an indication that the road segment was missed due to driver mistake (e.g., driver missed the turn, driver was confused about the turn-by-turn instructions, etc.), route assignment service 514 may generate a second mapping route having the missed road segment, and assign the second mapping route to a second mapping vehicle (different from the first mapping vehicle) in the fleet of mapping vehicles.

### User Interface to Assist Drivers of Mapping Vehicles and to Solicit User Feedback From Drivers of Mapping Vehicles

User interfaces for the driver applications 550 of FIGS. 5-6 can be designed to offer hands-free interactions to allow drivers of the mapping vehicles 520 to follow mapping routes and provide user feedback easily. In some embodiments, the user device implementing a driver application 550 that offers a user interface can receive one or more mapping routes, each mapping route having road segments of a road segment graph. Using semantic map data, the driver application 550 can generate turn-by-turn instructions (e.g., drive straight, turn left, turn right, keep left, keep right, take the next exit, etc.) based on the assigned mapping route. Through one or more user output devices, the turn-by-turn instructions can be output or provided to a driver of the vehicle.

In some embodiments, the driver application 550 can determine whether a road segment in the mapping route has been missed based on location data of the vehicle. The driver application 550 can, via one or more user output devices, output a request to the user for user feedback regarding the missed road segment. The driver application 550 can receive the user feedback through one or more of the user input devices. The driver application 550 can transmit the user feedback to a remote service (e.g., the route assignment service 514 of the route management service 510) that maintains the road segment graph and coverage information of the road segment graph.

FIG. 7 illustrates one or more user interactions through a user device 702 provided with a mapping vehicle, according to some aspects of the disclosed technology. User device 702 having the driver application (e.g., driver application 550 of FIGS. 5-6) may have a graphical user interface that displays turn-by-turn instructions, which may include a map view 706 (e.g., with a bent arrow 742 to indicate on the map that the driver should turn right on Broadway) and textual message 704 indicating the next instruction (e.g., “turn right on Broadway”). User device 702 having the driver application may include an audio user interface that outputs turn-by-turn instructions, which may include an audio message 710 indicating the next instruction (e.g., “turn right on Broadway”). A driver using the user device 702 may simply follow the turn-by-turn instructions, without needing specific knowledge of the mapping route(s) assigned to the driver.

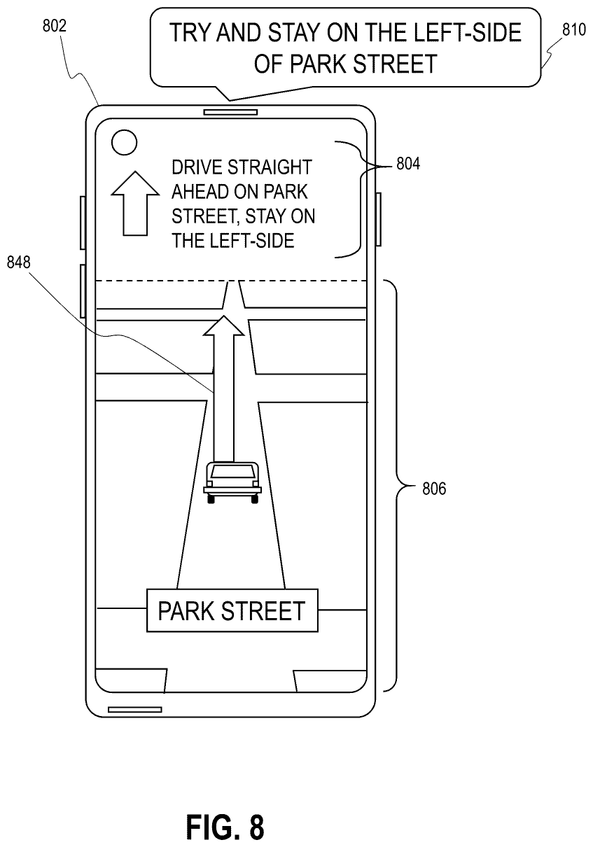

FIG. 8 illustrates one or more further user interactions through a user device 802 provided with a mapping vehicle, according to some aspects of the disclosed technology. In some cases, a driver may be prompted to drive in a certain/selected portion of a road segment to increase mapping data coverage of a certain/selected portion of the road segment. User device 802 having the driver application (e.g., driver application 550 of FIGS. 5-6) may have a graphical user interface that displays turn-by-turn instructions, which may include a map view 806 (e.g., with a straight arrow 848 placed on the left-side of the road on the map to indicate that the driver should stay on the left-side of the road) and textual message 804 indicating the next instruction with a further instruction to drive in a certain/selected portion of a road segment (e.g., “drive straight ahead on Park Street, stay on the left-side”). In this example, the assigned mapping route may specify that a mapping vehicle should drive through a specific portion of a road segment (e.g., left-side of a road segment) if coverage of that specific portion of the road segment is desirable. User device 802 having the driver application may include an audio user interface outputs turn-by-turn instructions, which may include an audio message 810 indicating the next instruction (e.g., “try and stay on the left-side of Park Street”).

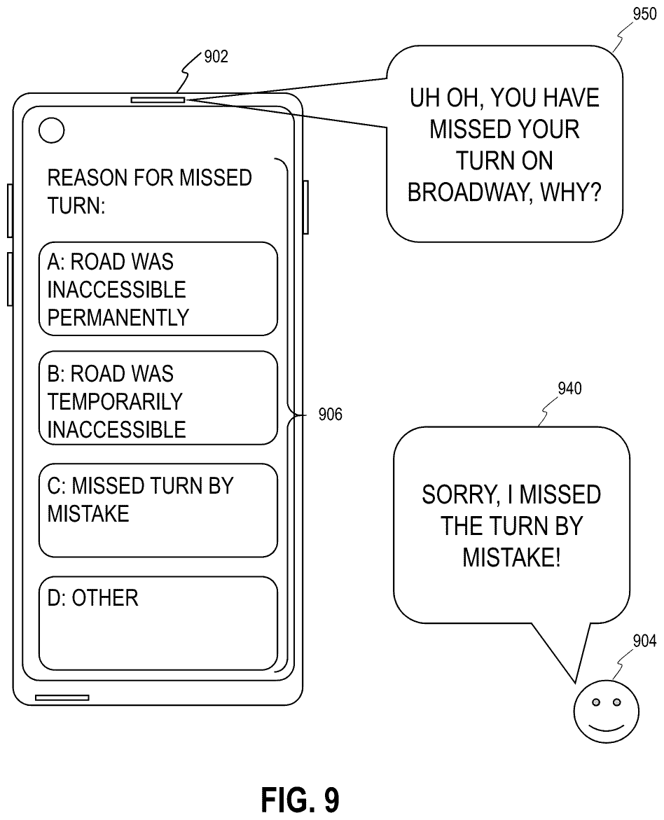

FIG. 9 illustrates one or more yet further user interactions through a user device 902 provided with a mapping vehicle, according to some aspects of the disclosed technology. Driver 904 may interact with the driving application (e.g., driver application 550 of FIGS. 5-6) implemented on user device 902 through one or more modalities, depending on one or more user input devices offered to the driver 904. Specifically, feedback (e.g., feedback on missed road segments) may be solicited from the driver 904 through the driver application, via one or more user output devices. Driver 904 may provide the feedback through the driver application, via one or more user input devices. The one or more output devices may include a display, and the request to the user for user feedback may include a textual message. The one or more output devices may include a speaker, and the request to the user for user feedback may include an audio message (e.g., audio message 950 saying “uh-oh, you have missed your turn on Broadway, why?”). The one or more user input devices may include a touch-sensitive display, and the user feedback is received as a user selection through a touch-sensitive display. For example, driver 904 may select from four different options shown in the graphical user interface 906 of the driver application implemented on user device 902. The one or more user input devices may include one or more buttons, and the user feedback is received as a button press of one or the button(s). The one or more user input devices may include a microphone, the user feedback is received as an audio signal through the microphone (e.g., driver 904 may utter an audio message 940 “sorry, I missed the turn by mistake”). The audio message may be parsed and interpreted by speech processing implemented on the user device 902 or on the remote service.

### Computer-Implemented Methods for Improving Route Management of Mapping Vehicles

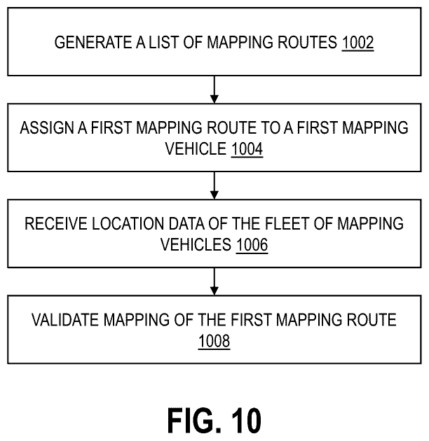

FIG. 10 is a flow diagram illustrating an exemplary computer-implemented method for managing mapping data collection performed by a fleet of mapping vehicles, according to some aspects of the disclosed technology. In 1002, a route management service (e.g., route management service 510) may generate a list of mapping routes based on a road segment graph of an operational design domain. In 1004, the route management service may assign a first mapping route to a first mapping vehicle in the fleet of mapping vehicles, wherein the first mapping route comprises first road segments of the road segment graph. In 1006, the route management service may receive location data of the fleet of mapping vehicles. In 1008, the route management service may validate mapping of the first mapping route based on location data from the first mapping vehicle and the first road segments of the first mapping route.

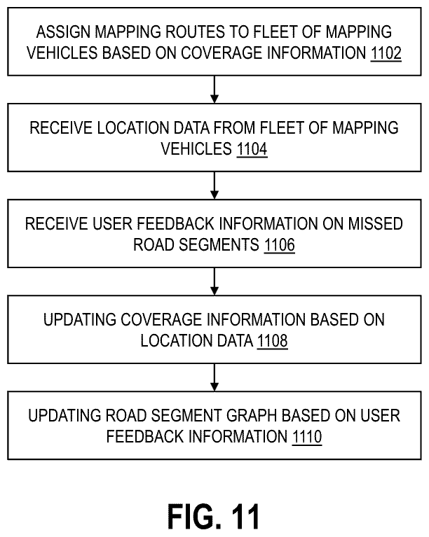

FIG. 11 is a flow diagram illustrating another exemplary computer-implemented method for managing mapping data collection performed by a fleet of mapping vehicles, according to some aspects of the disclosed technology. In 1102, a route management service (e.g., route management service 510 of FIG. 5) may assign mapping routes to a fleet of mapping vehicles based on coverage information of a road segment graph corresponding to an operational design domain. In 1104, the route management service may receive location data from the fleet of mapping vehicles. In 1106, the route management service may receive user feedback information from drivers of the fleet of mapping vehicles regarding one or more missed road segments of assigned mapping routes. In 1008, the route management service may update the coverage information based on the location data. In 1110, the route management service may update the road segment graph based on the user feedback information.

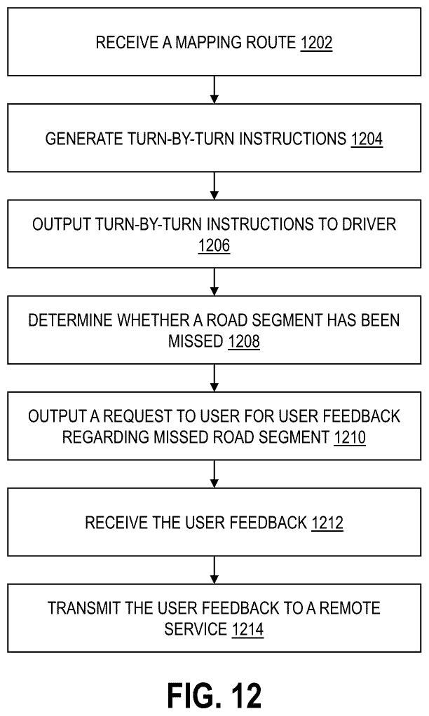

FIG. 12 is a flow diagram illustrating an exemplary computer-implemented method for method for generating turn-by-turn instructions to a driver of a mapping vehicle and soliciting user feedback regarding a missed road segment, according to some aspects of the disclosed technology, according to some aspects of the disclosed technology. In 1202, a driver application implemented on a user device may receive a mapping route having road segments of a road segment graph. The driver application can implement a user interface to interact with a driver of a mapping vehicle. The user device may be co-located with the mapping vehicle. In 1204, the driver application may generate turn-by-turn instructions based on the mapping route (in some cases, the turn-by-turn instructions may be provided by a different source). In 1206, the driver application may output turn-by-turn instructions to a driver of the vehicle via the one or more user output devices. In 1208, the driver application may determine whether a road segment in the mapping route has been missed based on location data of the vehicle (location data may originate from the location sensor of the user device or a location sensor of the vehicle). In 1210, the driver application may output a request to the user for user feedback regarding the missed road segment via the one or more user output devices. In 1212, the driver application may receive the user feedback through one or more of the user input devices. In 1214, the driver application may transmit the user feedback to a remote service (e.g., route management service 510 of FIG. 5) that maintains a road segment graph and coverage information of the road segment graph.

### Exemplary AV Management System

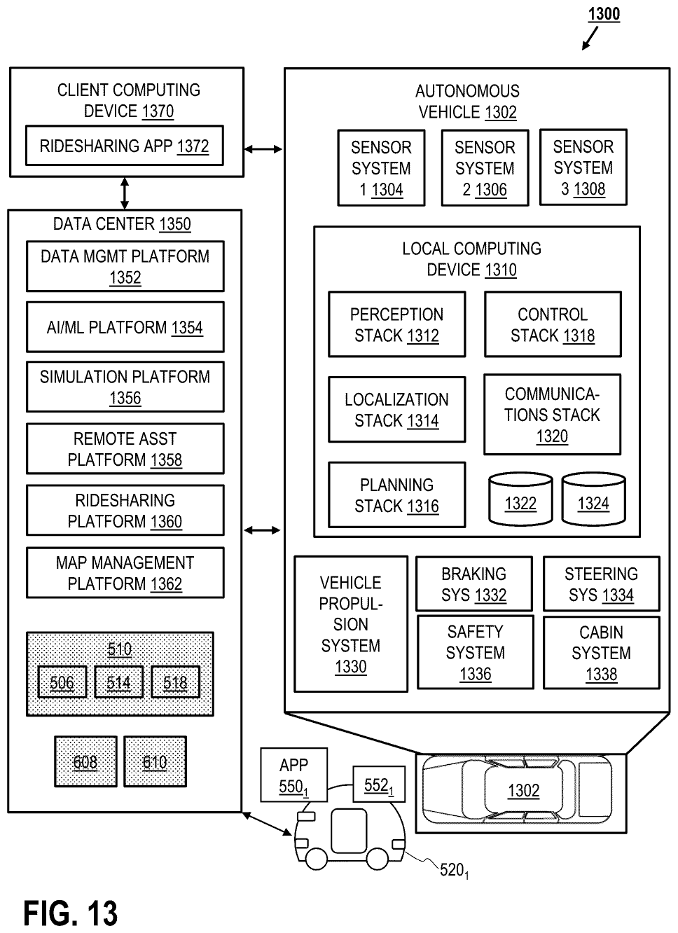

Turning now to FIG. 13, this figure illustrates an example of an AV management system 1300, in which some of the aspects of the present disclosure can be implemented. One of ordinary skill in the art will understand that, for the AV management system 1300 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 1300 includes an AV 1302, a data center 1350, a client computing device 1370, and one or more mapping vehicles 520. The AV 1302, the data center 1350, the client computing device 1370, and one or more mapping vehicles 520 may communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 1302 may navigate about roadways without a human driver based on sensor signals generated by multiple sensor systems 1304, 1306, and 1308. The sensor systems 1304-1308 may include different types of sensors and may be arranged about the AV 1302. For instance, the sensor systems 1304-1308 may comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 1304 may be a camera system, the sensor system 1306 may be a LIDAR system, and the sensor system 1308 may be a RADAR system. Other embodiments may include any other number and type of sensors.

AV 1302 may also include several mechanical systems that may be used to maneuver or operate AV 1302. For instance, the mechanical systems may include vehicle propulsion system 1330, braking system 1332, steering system 1334, safety system 1336, and cabin system 1338, among other systems. Vehicle propulsion system 1330 may include an electric motor, an internal combustion engine, or both. The braking system 1332 may include an engine brake, a wheel braking system (e.g., a disc braking system that utilizes brake pads), hydraulics, actuators, and/or any other suitable componentry configured to assist in decelerating AV 1302. The steering system 1334 may include suitable componentry configured to control the direction of movement of the AV 1302 during navigation. Safety system 1336 may include lights and signal indicators, a parking brake, airbags, and so forth. The cabin system 1338 may 1338 may include cabin temperature control systems, in-cabin entertainment systems, and so forth. In some embodiments, the AV 1302 may not include human driver actuators (e.g., steering wheel, handbrake, foot brake pedal, foot accelerator pedal, turn signal lever, window wipers, etc.) for controlling the AV 1302. Instead, the cabin system 1338 may include one or more client interfaces (e.g., GUIs, Voice User Interfaces (VUIs), etc.) for controlling certain aspects of the mechanical systems 1330-1338.

AV 1302 may additionally include a local computing device 1310 that is in communication with the sensor systems 1304-1308, the mechanical systems 1330-1338, the data center 1350, and the client computing device 1370, among other systems. The local computing device 1310 may include one or more processors and memory, including instructions that may be executed by the one or more processors. The instructions may make up one or more software stacks or components responsible for controlling the AV 1302; communicating with the data center 1350, the client computing device 1370, and other systems; receiving inputs from riders, passengers, and other entities within the AV's environment; logging metrics collected by the sensor systems 1304-1308; and so forth. In this example, the local computing device 1310 includes a perception stack 1312, a mapping and localization stack 1314, a planning stack 1316, a control stack 1318, a communications stack 1320, an HD geospatial database 1322, and an AV operational database 1324, among other stacks and systems.

Perception stack 1312 may enable the AV 1302 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 1304-1308, the mapping and localization stack 1314, the HD geospatial database 1322, other components of the AV, and other data sources (e.g., the data center 1350, the client computing device 1370, third-party data sources, etc.). The perception stack 1312 may detect and classify objects and determine their current and predicted locations, speeds, directions, and the like. In addition, the perception stack 1312 may 1312 may determine the free space around the AV 1302 (e.g., to maintain a safe distance from other objects, change lanes, park the AV, etc.). The perception stack 1312 may also identify environmental uncertainties, such as where to look for moving objects, flag areas that may be obscured or blocked from view, and so forth.

Mapping and localization stack 1314 may determine the AV's position and orientation (pose) using different methods from multiple systems (e.g., GPS, IMUs, cameras, LIDAR, RADAR, ultrasonic sensors, the HD geospatial database 1322, etc.). For example, in some embodiments, the AV 1302 may compare sensor data captured in real-time by the sensor systems 1304-1308 to data in the HD geospatial database 1322 to determine its precise (e.g., accurate to the order of a few centimeters or less) position and orientation. The AV 1302 may 1302 may focus its search based on sensor data from one or more first sensor systems (e.g., GPS) by matching sensor data from one or more second sensor systems (e.g., LIDAR). If the mapping and localization information from one system is unavailable, the AV 1302 may use mapping and localization information from a redundant system and/or from remote data sources.

The planning stack 1316 may determine how to maneuver or operate the AV 1302 safely and efficiently in its environment. For example, the planning stack 1316 may receive the location, speed, and direction of the AV 1302, geospatial data, data regarding objects sharing the road with the AV 1302 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 1302 from one point to another. The planning stack 1316 may determine multiple sets of one or more mechanical operations that the AV 1302 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 1316 may select from multiple backup plans to carry out. For example, while preparing to change lanes to turn right at an intersection, another vehicle may aggressively cut into the destination lane, making the lane change unsafe. The planning stack 1316 could have already determined an alternative plan for such an event, and upon its occurrence, help to direct the AV 1302 to go around the block instead of blocking a current lane while waiting for an opening to change lanes.

The control stack 1318 may manage the operation of the vehicle propulsion system 1330, the braking system 1332, the steering system 1334, the safety system 1336, and the cabin system 1338. The control stack 1318 may receive sensor signals from the sensor systems 1304-1308 as well as communicate with other stacks or components of the local computing device 1310 or a remote system (e.g., the data center 1350) to effectuate operation of the AV 1302.

For example, the control stack 1318 may implement the final path or actions from the multiple paths or actions provided by the planning stack 1316. Implementation may involve turning the routes and decisions from the planning stack 1316 into commands for the actuators that control the AV's steering, throttle, brake, and drive unit.

The communication stack 1320 may transmit and receive signals between the various stacks and other components of the AV 1302 and between the AV 1302, the data center 1350, the client computing device 1370, and other remote systems. The communication stack 1320 may enable the local computing device 1310 to exchange information remotely over a network. The communication stack 1320 may also facilitate local exchange of information, such as through a wired connection or a local wireless connection.

The HD geospatial database 1322 may store HD maps and related data of the streets upon which the AV 1302 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left-turn lanes; permissive, protected/permissive, or protected only U-turn lanes; permissive or protected only right-turn lanes; etc.). The traffic controls layer may include geospatial information of traffic signal lights, traffic signs, and other road objects and related attributes.

The AV operational database 1324 may store raw AV data generated by the sensor systems 1304-1308 and other components of the AV 1302 and/or data received by the AV 1302 from remote systems (e.g., the data center 1350, the client computing device 1370, etc.). In some embodiments, the raw AV data may include HD LIDAR point cloud data, image or video data, RADAR data, GPS data, and other sensor data that the data center 1350 may use for creating or updating AV geospatial data as discussed further below with respect to FIG. 5 and elsewhere in the present disclosure.

The data center 1350 may be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 1350 may 1350 may include one or more computing devices remote to the local computing device 1310 for managing a fleet of AVs and AV-related services. For example, in addition to managing the AV 1302, the data center 1350 may also support a ridesharing service, a delivery service, a remote/roadside assistance service, street services (e.g., street mapping, street patrol, street cleaning, street metering, parking reservation, etc.), and the like.

The data center 1350 may send and receive various signals to and from the AV 1302 and the client computing device 1370. These signals may include sensor data captured by the sensor systems 1304-1308, roadside assistance requests, software updates, ridesharing pick-up and drop-off instructions, and so forth. In this example, the data center 1350 includes one or more of a data management platform 1352, an Artificial Intelligence/Machine Learning (AI/ML) platform 1354, a simulation platform 1356, a remote assistance platform 1358, a ridesharing platform 1360, and a map management platform 1362, among other systems.

Data management platform 1352 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, mapping data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 1350 may access data stored by the data management platform 1352 to provide their respective services.

The AI/ML platform 1354 may provide the infrastructure for training and evaluating machine learning algorithms for operating the AV 1302, the simulation platform 1356, the remote assistance platform 1358, the ridesharing platform 1360, the map management platform 1362, and other platforms and systems. Using the AI/ML platform 1354, data scientists may prepare data sets from the data management platform 1352; select, design, and train machine learning models; evaluate, refine, and deploy the models; maintain, monitor, and retrain the models; and so on.

The remote assistance platform 1358 may generate and transmit instructions regarding the operation of the AV 1302. For example, in response to an output of the AI/ML platform 1354 or other system of the data center 1350, the remote assistance platform 1358 may prepare instructions for one or more stacks or other components of the AV 1302.

The ridesharing platform 1360 may interact with a customer of a ridesharing service via a ridesharing application 1372 executing on the client computing device 1370. The ridesharing platform 1360 may not be limited to ridesharing, but can also provide other services such as ridehailing and deliveries. The client computing device 1370 may be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general-purpose computing device for accessing the ridesharing application 1372. The client computing device 1370 may be a customer's mobile computing device or a computing device integrated with the AV 1302 (e.g., the local computing device 1310). The ridesharing platform 1360 may receive requests to be picked up or dropped off from the ridesharing application 1372 and dispatch the AV 1302 for the trip.

Map management platform 1362 may provide a set of tools for the manipulation and management of geographic and spatial (geospatial) and related attribute data. The data management platform 1352 may receive LIDAR point cloud data, image data (e.g., still image, video, etc.), RADAR data, GPS data, and other sensor data (e.g., raw data) from one or more AVs 1302, Unmanned Aerial Vehicles (UAVs), satellites, third-party mapping services, and other sources of geospatially referenced data. The raw data may be processed, and map management platform 1362 may render base representations (e.g., tiles (2D), bounding volumes (3D), etc.) of the AV geospatial data to enable users to view, query, label, edit, and otherwise interact with the data. Map management platform 1362 may manage workflows and tasks for operating on the AV geospatial data. Map management platform 1362 may control access to the AV geospatial data, including granting or limiting access to the AV geospatial data based on user-based, role-based, group-based, task-based, and other attribute-based access control mechanisms. Map management platform 1362 may provide version control for the AV geospatial data, such as to track specific changes that (human or machine) map editors have made to the data and to revert changes when necessary. Map management platform 1362 may 1362 may administer release management of the AV geospatial data, including distributing suitable iterations of the data to different users, computing devices, AVs, and other consumers of HD maps. Map management platform 1362 may provide analytics regarding the AV geospatial data and related data, such as to generate insights relating to the throughput and quality of mapping tasks.

In some embodiments, the map viewing services of map management platform 1362 may be modularized and deployed as part of one or more of the platforms and systems of the data center 1350. For example, the AI/ML platform 1354 may incorporate the map viewing services for visualizing the effectiveness of various object detection or object classification models, the simulation platform 1356 may incorporate the map viewing services for recreating and visualizing certain driving scenarios, the remote assistance platform 1358 may incorporate the map viewing services for replaying traffic incidents to facilitate and coordinate aid, the ridesharing platform 1360 may incorporate the map viewing services into the ridesharing application 1372 to enable passengers to view the AV 1302 in transit en-route to a pick-up or drop-off location, and so on.

In some embodiments the data center 1350 may include one or more of 510, 506, 514, 518, 608, and 610 as illustrated in FIGS. 5-6. Route management service 510 may assist in gathering mapping data for an operational design domain, using a fleet of mapping vehicles 520 as illustrated in FIGS. 5-6. The mapping data may later be consumed by map management platform 1362 to enable a variety of services and capabilities being provided by AVs and/or platforms implemented on data center 1350. Map management platform 1362 may provide mapping data to various mapping data consumers, including but not limited to the AV 1302, data management platform 1352, AI/ML platform 1354, simulation platform 1356, remote assistance platform 1358, ridesharing platform 1360, etc.

### Exemplary Processor-Based System

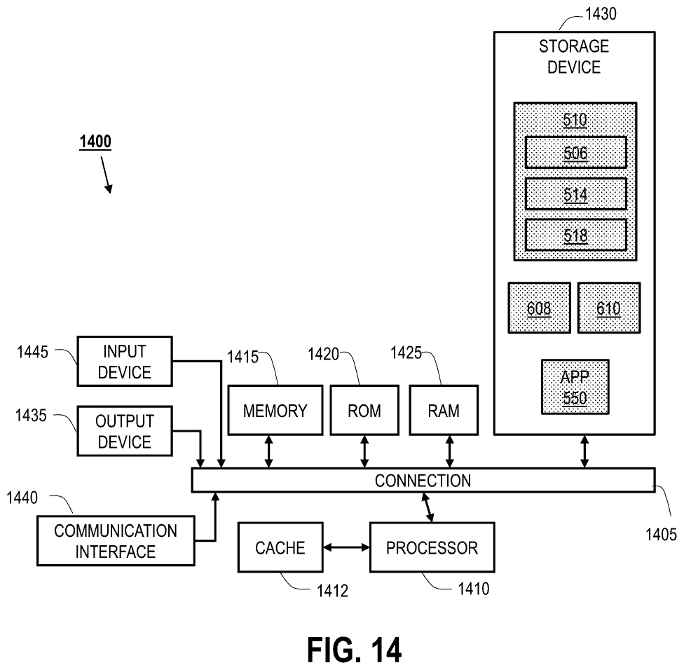

FIG. 14 illustrates an example processor-based system with which some aspects of the subject technology may be implemented. For example, processor-based system 1400 may be any computing device making up, or any component thereof in which the components of the system are in communication with each other using connection 1405. Connection 1405 may 1405 may be a physical connection via a bus, or a direct connection into processor 1410, such as in a chipset architecture. Connection 1405 may also be a virtual connection, networked connection, or logical connection.

In some embodiments, computing system 1400 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1400 includes at least one processing unit (Central Processing Unit (CPU) or processor) 1410 (e.g., one or more processors) and connection 1405 that couples various system components including system memory 1415, such as Read-Only Memory (ROM) 1420 and Random-Access Memory (RAM) 1425 to processor 1410. Computing system 1400 may include a cache of high-speed memory 1412 connected directly with, in close proximity to, or integrated as part of processor 1410.

Processor 1410 may include any general-purpose processor and a hardware service or software service, implementing functionalities carried out by one or more of 510, 506, 514, 518, 608, and 610 as illustrated in FIGS. 5-6. Processor 1410 may essentially be a completely self-contained computing system, containing multiple cores or processors, a bus, memory controller, cache, etc. A multi-core processor may be symmetric or asymmetric.

To enable user interaction, computing system 1400 may implement driver application 550 as illustrated in FIGS. 5-6. Computing system 1400 may include an input device 1445 (e.g., one or more user input devices), which may represent any number of input mechanisms, such as a microphone for speech, a touch-sensitive screen for gesture or graphical input, keyboard, mouse, motion input, speech, virtual or physical buttons, etc. Computing system 1400 may 1400 may also include output device 1435 (e.g., one or more user output devices), which may be one or more of a number of output mechanisms known to those of skill in the art, such as a display, a speaker, etc. In some instances, multimodal systems may enable a user to provide multiple types of input/output to communicate with computing system 1400. Computing system 1400 may include communications interface 1440, which may generally govern and manage the user input and system output. The communication interface may perform or facilitate receipt and/or transmission wired or wireless communications via wired and/or wireless transceivers.

Communication interface 1440 may also include one or more GNSS receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS.

Storage device 1430 may be a non-volatile and/or non-transitory and/or computer-readable memory device and may be a hard disk or other types of computer-readable media which may store data that are accessible by a computer.

Storage device 1430 may include software services, servers, services, etc., that when the code that defines such software is executed by the processor 1410, it causes the system 1400 to perform a function. In some embodiments, a hardware service that performs a particular function may include the software component stored in a computer-readable medium in connection with the necessary hardware components, such as processor 1410, connection 1405, output device 1435, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special-purpose computer, including the functional design of any special-purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network personal computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### SELECT EXAMPLES

Example 1 is a computer-implemented method for managing mapping data collection performed by a fleet of mapping vehicles, the computer-implemented method comprising: generating a list of mapping routes based on a road segment graph of an operational design domain; assigning a first mapping route to a first mapping vehicle in the fleet of mapping vehicles, wherein the first mapping route comprises first road segments of the road segment graph; receiving location data of the fleet of mapping vehicles; and validating mapping of the first mapping route based on location data from the first mapping vehicle and the first road segments of the first mapping route.

In Example 2, the computer-implemented method of Example 1 can optionally include: in response to the first mapping vehicle deviating from the first mapping route and an indication that a road segment in the first mapping route was missed due to permanent inaccessibility, removing the missed road segment from the road segment graph.

In Example 3, the computer-implemented method of Example 1 or 2 can optionally include: in response to the first mapping vehicle deviating from the first mapping route and an indication that a road segment in the first mapping route was missed due to driver mistake, modifying the first mapping route to reroute the first mapping vehicle to the missed road segment.

In Example 4, the computer-implemented method of Example 1 or 2 can optionally include: in response to the first mapping vehicle deviating from the first mapping route and an indication that a road segment in the first mapping route was missed due to driver mistake, generating a second mapping route having the missed road segment, and assigning the second mapping route to the first mapping vehicle.

In Example 5, the computer-implemented method of Example 1 or 2 can optionally include: in response to the first mapping vehicle deviating from the first mapping route and an indication that a road segment in the first mapping route was missed due to driver mistake, generating a second mapping route having the missed road segment, and assigning the second mapping route to a second mapping vehicle in the fleet of mapping vehicles.

In Example 6, the computer-implemented method of any one of Examples 1-5 can optionally include: in response to the first mapping vehicle deviating from the first mapping route and an indication that a road segment in the first mapping route was missed due to temporary inaccessibility, generating a second mapping route having the missed road segment, and assigning the second mapping route to one of the mapping vehicles in the fleet of mapping vehicles at a later time.

In Example 7, the computer-implemented method of any one of Examples 1-6 can optionally include: the list of mapping routes being prioritized based on priorities assigned to areas of the operational design domain.

In Example 8, the computer-implemented method of Example 7 can optionally include assigning the first mapping route to the first mapping vehicle comprising: assigning the first mapping route based on priorities of the mapping routes.

In Example 9, the computer-implemented method of any one of Examples 1-8 can optionally include assigning the first mapping route to the first mapping vehicle comprising: assigning the first mapping route based on shift durations of drivers operating the fleet of mapping vehicles.

In Example 10, the computer-implemented method of any one of Examples 1-9 can optionally include assigning the first mapping route to the first mapping vehicle comprising: assigning the first mapping route based on shift starting times and shift ending times of drivers operating the fleet of mapping vehicles.

In Example 11, the computer-implemented method of any one of Examples 1-10 can optionally include assigning the first mapping route to the first mapping vehicle comprising: assigning the first mapping route based on location of drivers operating the fleet of mapping vehicles.

In Example 12, the computer-implemented method of any one of Examples 1-11 can optionally include generating the list of mapping routes comprising: generating the list of mapping routes based on coverage information corresponding to nodes and edges of the road segment graph.

In Example 13, the computer-implemented method of any one of Examples 1-12 can optionally include validating comprising: validating the location data from the first mapping vehicle against location information of the road segments in the first mapping route.

In Example 14, the computer-implemented method of Example 12 or 13 can optionally include: updating the coverage information of nodes and edges of the road segment graph based on the location data received from the fleet of mapping vehicles, wherein the nodes and edges correspond to road segments in the list of mapping routes.

In Example 15, the computer-implemented method of any one of Examples 12-14 can optionally include: maintaining the coverage information of nodes and edges of the road segment graph based on the location data received from the fleet of mapping vehicles; and wherein the coverage information for a node or an edge indicates whether the node or the edge has been driven by a mapping vehicle in the fleet or has not been driven by a mapping vehicle in the fleet.

In Example 16, the computer-implemented method of any one of Examples 12-15 can optionally include: maintaining the coverage information of nodes and edges of the road segment graph based on the location data received from the fleet of mapping vehicles; and wherein the coverage information for a node or an edge indicates a number of times one or more mapping vehicles in the fleet has driven past the node or through the edge of the road segment graph.

In Example 17, the computer-implemented method of Example 16 can optionally include: the coverage information for a node or an edge indicating the node or the edge is covered by the fleet of mapping vehicles if the number of times meets a minimum number, and indicates the node or the edge is not-covered by the fleet of mapping vehicles if the number of times does not meet the minimum number.

In Example 18, the computer-implemented method of Example 17 can optionally include the minimum number for the node or the edge being based on a speed limit corresponding to the node or the edge.

In Example 19, the computer-implemented method of Example 17 or 18 can optionally include the minimum number for the node or the edge being based on whether the node or the edge is at or near an intersection.

In Example 20, the computer-implemented method of any one of Examples 17-19 can optionally include the minimum number for the node or the edge being based on a number of lanes corresponding to the node or the edge.

In Example 21, the computer-implemented method of any one of Examples 12-20 can optionally include: maintaining the coverage information of nodes and edges of the road segment graph based on the location data received from the fleet of mapping vehicles; and wherein the coverage information for a node or an edge indicates whether individual portions of the node or the edge has been driven by a mapping vehicle in the fleet or has not been driven by a mapping vehicle in the fleet.

In Example 22, the computer-implemented method of any one of Examples 1-21 can optionally include: receiving user feedback from a user interface that indicates whether the road segment was missed due to one of the following reasons: (1) permanent inaccessibility; (2) temporary inaccessibility; (3) driver mistake; and (4) other.

In Example 23, the computer-implemented method of any one of Examples 12-22 can optionally include: receiving sensor data from the fleet of mapping vehicles; processing the sensor data to validate quality of the sensor data; and in response to sensor data corresponding to a node or an edge not meeting a quality metric, updating the coverage information corresponding to the node or the edge.

In Example 24, the computer-implemented method of any one of Examples 1-23 can optionally include: further comprising: causing a map visualizer user interface to display a geographical map of the operational design domain and overlay of visual indicators corresponding to coverage information of nodes and edges of the road segment graph.

In Example 25, the computer-implemented method of Example 24 can optionally include the visual indicators for a node or an edge including a first visual indicator encoding state information indicating whether the node or the edge of the road segment graph has been driven or not been driven by the fleet of mapping vehicles.

In Example 26, the computer-implemented method of Example 24 or 25 can optionally include the visual indicators for a node or an edge including a second visual indicator encoding count information indicating a number of times one or more of the mapping vehicles has driven past the node or through the edge.

In Example 27, the computer-implemented method of Example 26 can optionally include the visual indicators for a node or an edge including a third visual indicator encoding state information indicating whether the count information meets a minimum number for the node or the edge.

In Example 28, the computer-implemented method of any one of Examples 24-27 can optionally include the visual indicators for a node or an edge including a fourth visual indicator encoding progress information indicating progress of post-processing of the mapping data collected for the node or the edge.

In Example 29, the computer-implemented method of any one of Examples 24-28 can optionally include the visual indicators for a node or an edge including a fifth visual indicator encoding mapping failure information.

Example 30 is a computer-implemented method for managing mapping data collection performed by a fleet of mapping vehicles, the computer-implemented method comprising: assigning mapping routes to a fleet of mapping vehicles based on coverage information of a road segment graph corresponding to an operational design domain; receiving location data from the fleet of mapping vehicles; receiving user feedback information from drivers of the fleet of mapping vehicles regarding one or more missed road segments of assigned mapping routes; updating the coverage information based on the location data; and updating the road segment graph based on the user feedback information.

In Example 31, the computer-implemented method of Example 30 may optionally include features in Examples 2-29.

Example 32 is a computing system of a vehicle, comprising: one or more processors; one or more storage devices; one or more user input devices; one or more user output devices; wherein the one or more storage devices store instructions, that when executed by the one or more processors, causes the computing system to: receive a mapping route having road segments of a road segment graph; generate turn-by-turn instructions based on the mapping route; output turn-by-turn instructions to a driver of the vehicle via the one or more user output devices; determine whether a road segment in the mapping route has been missed based on location data of the vehicle; output a request to the user for user feedback regarding the missed road segment via the one or more user output devices; receive the user feedback through one or more of the user input devices; and transmit the user feedback to a remote service that maintains a road segment graph and coverage information of the road segment graph.

In Example 33, the computing system of Example 32 can optionally include the request to the user for the user feedback comprising an audio message.

In Example 34, the computing system of Example 32 or 33 can optionally include the one or more user input devices comprising a microphone, and the user feedback is received as an audio signal through the microphone.

In Example 35, the computing system of any one of Examples 32-34 can optionally include the request to the user for the user feedback comprising a textual message.

In Example 36, the computing system of any one of Examples 32-35 can optionally include the one or more user input devices comprising a touch-sensitive display, and the user feedback is received as a user selection through a touch-sensitive display.

In Example 37, the computing system of any one of Examples 32-36 can optionally include the one or more user input devices comprising buttons, and the user feedback is received as a button press of one of the buttons.

In Example 38, the computing system of any one of Examples 32-37 can optionally include the mapping route comprising instructions to drive in a selected portion of a road segment, and the turn-by-turn instructions comprises instructions to the driver of the vehicle to drive in the selected portion of the road segment.

In Example 39, the computing system of any one of Examples 32-38 can optionally include the user feedback indicating one of the following: (1) road segment was missed due to permanent inaccessibility; (2) road segment was missed due to temporary inaccessibility; (3) road segment was missed due to driver mistake; and (4) road segment was missed due to other reasons.

Example 40 is a computer-implemented method comprising: receiving a mapping route having road segments of a road segment graph; generating turn-by-turn instructions based on the mapping route; outputting turn-by-turn instructions to a driver of the vehicle via the one or more user output devices; determining whether a road segment in the mapping route has been missed based on location data of the vehicle; outputting a request to the user for user feedback regarding the missed road segment via the one or more user output devices; receive the user feedback through one or more of the user input devices; and transmitting the user feedback to a remote service that maintains a road segment graph and coverage information of the road segment graph.

Example 41 is a computing system, comprising: one or more processors; and one or more storage devices; wherein the one or more storage devices store instructions, that when executed by the one or more processors, causes the computing system to: generate a list of mapping routes based on a road segment graph of an operational design domain; assign a first mapping route to a first mapping vehicle in a fleet of mapping vehicles, wherein the first mapping route comprises first road segments of the road segment graph; receive location data of the first mapping vehicle; receive user feedback information from a driver of the first mapping vehicle regarding a missed road segment; validate mapping of the first mapping route based on location data from the first mapping vehicle and the first road segments of the first mapping route; update coverage information of the road segment graph based on results of validating the mapping of the first mapping route; and update the road segment graph based on the user feedback information.

Example 42 is a computer-implemented method comprising: generating a list of mapping routes based on a road segment graph of an operational design domain; assign a first mapping route to a first mapping vehicle in a fleet of mapping vehicles, wherein the first mapping route comprises first road segments of the road segment graph; receiving location data of the first mapping vehicle; receiving user feedback information from a driver of the first mapping vehicle regarding a missed road segment; validating mapping of the first mapping route based on location data from the first mapping vehicle and the first road segments of the first mapping route; updating coverage information of the road segment graph based on results of validating the mapping of the first mapping route; and updating the road segment graph based on the user feedback information.

Example A is a computing system, comprising: one or more processors; and one or more storage devices; wherein the one or more storage devices store instructions, that when executed by the one or more processors, causes the computing system to perform any one of the computer-implemented methods of Examples 1-31, 40 and 42.

Example B is an apparatus comprising means to carry out or perform any one of the computer-implemented methods of Examples 1-3, 40 and 42.

1. A computer-implemented method for managing mapping data collection performed by a fleet of mapping vehicles, the computer-implemented method comprising:
generating a list of mapping routes based on a road segment graph of an operational design domain;
assigning a first mapping route to a first mapping vehicle in the fleet of mapping vehicles, wherein the first mapping route comprises first road segments of the road segment graph;
receiving location data of the fleet of mapping vehicles; and
validating mapping of the first mapping route based on location data from the first mapping vehicle and the first road segments of the first mapping route.

2. The computer-implemented method of claim 1, further comprising:
in response to the first mapping vehicle deviating from the first mapping route and an indication that a road segment in the first mapping route was missed due to permanent inaccessibility, removing the missed road segment from the road segment graph.

3. The computer-implemented method of claim 1, further comprising:
in response to the first mapping vehicle deviating from the first mapping route and an indication that a road segment in the first mapping route was missed due to driver mistake, modifying the first mapping route to reroute the first mapping vehicle to the missed road segment.

4. The computer-implemented method of claim 1, further comprising:
in response to the first mapping vehicle deviating from the first mapping route and an indication that a road segment in the first mapping route was missed due to driver mistake, generating a second mapping route having the missed road segment, and assigning the second mapping route to the first mapping vehicle.

5. The computer-implemented method of claim 1, further comprising:
in response to the first mapping vehicle deviating from the first mapping route and an indication that a road segment in the first mapping route was missed due to driver mistake, generating a second mapping route having the missed road segment, and assigning the second mapping route to a second mapping vehicle in the fleet of mapping vehicles.

6. The computer-implemented method of claim 1, further comprising:
in response to the first mapping vehicle deviating from the first mapping route and an indication that a road segment in the first mapping route was missed due to temporary inaccessibility, generating a second mapping route having the missed road segment, and assigning the second mapping route to one of the mapping vehicles in the fleet of mapping vehicles at a later time.

7. The computer-implemented method of claim 1, wherein the list of mapping routes are prioritized based on priorities assigned to areas of the operational design domain.

8. The computer-implemented method of claim 1, wherein generating the list of mapping routes comprises:
generating the list of mapping routes based on coverage information corresponding to nodes and edges of the road segment graph.

9. The computer-implemented method of claim 1, wherein validating the mapping of the first mapping route comprises:
validating the location data from the first mapping vehicle against location information of the road segments in the first mapping route.

10. The computer-implemented method of claim 1, further comprising:
receiving sensor data from the fleet of mapping vehicles;
processing the sensor data to validate quality of the sensor data; and
in response to sensor data corresponding to a node or an edge not meeting a quality metric, updating coverage information corresponding to the node or the edge.

11. The computer-implemented method of claim 1, further comprising:
causing a map visualizer user interface to display a geographical map of the operational design domain and overlay of visual indicators corresponding to coverage information of nodes and edges of the road segment graph.

12. A computer-implemented method for managing mapping data collection performed by a fleet of mapping vehicles, the computer-implemented method comprising:
assigning mapping routes to a fleet of mapping vehicles based on coverage information of a road segment graph corresponding to an operational design domain;
receiving location data from the fleet of mapping vehicles;
receiving user feedback information from drivers of the fleet of mapping vehicles regarding one or more missed road segments of assigned mapping routes;
updating the coverage information based on the location data; and
updating the road segment graph based on the user feedback information.

13. The computer-implemented method of claim 12, wherein updating the coverage information comprises:
maintaining the coverage information of nodes and edges of the road segment graph based on the location data received from the fleet of mapping vehicles and location information of road segments of mapping routes completed by the fleet of mapping vehicles.

14. The computer-implemented method of claim 12, wherein the coverage information for a node or an edge indicates whether the node or the edge has been driven by a mapping vehicle in the fleet or has not been driven by a mapping vehicle in the fleet.

15. The computer-implemented method of claim 12, wherein the coverage information for a node or an edge indicates a number of times one or more mapping vehicles in the fleet has driven past the node or through the edge of the road segment graph.

16. The computer-implemented method of claim 15, wherein the coverage information for a node or an edge indicates the node or the edge is covered by the fleet of mapping vehicles if the number of times meets a minimum number, and indicates the node or the edge is not-covered by the fleet of mapping vehicles if the number of times does not meet the minimum number.

17. The computer-implemented method of claim 16, wherein the minimum number for the node or the edge is based on a speed limit corresponding to the node or the edge.

18. The computer-implemented method of claim 12, wherein the coverage information for a node or an edge indicates whether individual portions of the node or the edge has been driven by a mapping vehicle in the fleet or has not been driven by a mapping vehicle in the fleet.

19. The computer-implemented method of claim 12, wherein the user feedback information indicates whether a particular road segment was missed due to one of the following reasons:
(1) permanent inaccessibility;
(2) temporary inaccessibility;
(3) driver mistake; and
(4) other.

20. A computing system, comprising:
one or more processors; and
one or more storage devices;
wherein the one or more storage devices store instructions, that when executed by the one or more processors, causes the computing system to:
generate a list of mapping routes based on a road segment graph of an operational design domain;
assign a first mapping route to a first mapping vehicle in a fleet of mapping vehicles, wherein the first mapping route comprises first road segments of the road segment graph;
receive location data of the first mapping vehicle;
receive user feedback information from a driver of the first mapping vehicle regarding a missed road segment;
validate mapping of the first mapping route based on location data from the first mapping vehicle and the first road segments of the first mapping route;
update coverage information of the road segment graph based on results of validating the mapping of the first mapping route; and
update the road segment graph based on the user feedback information.
